(19) United States
(12) Patent Application Publication
(10) Pub. No.: US 2005/0289075 A1
(43) Pub. Date: Dec. 29, 2005

(54) Removable media-based unified application installer and license management facility

(76) Inventors: Robert J. Murphy, Belmont, CA (US); John Hanay, Palo Alto, CA (US)

Correspondence Address: Robert J. Murphy, 1152 Village Dr., Belmont, CA, 94002, US

(21) Appl. No.: 11/167,009

(22) Filed: Jun. 24, 2005

Related U.S. Application Data
(60) Provisional application No. 60/583,285, filed on Jun. 25, 2004.

(51) Int. Cl. H04L 9/00

(52) U.S. Cl. 705/59

(57) ABSTRACT

An application installer and license management facility method and system are disclosed. The method enables a seller to distribute an application, one or more licenses, and an installation application using removable media. The application installer and license management facility provide a means by which a user may employ the removable media to transport files from device to device, insert the removable media into the device causing the installation application to automatically launch, and use the installation application to alternately install the application and a single license onto the device, re-install the application and license onto a previously licensed device without using an additional license, and un-install the application and license from the device, thereby, recouping the license for use on another device.

### CROSS REFERENCE TO RELATED APPLICATIONS

The present application claims priority under 35 U.S.C. 119(e) from provisional patent application Ser. No. 60/583,285, entitled “Removable Media-Based, Unified Application Installer and License Management Facility”, filed on Jun. 25, 2004, the disclosure of which is herein incorporated by reference in its entirety.

### BACKGROUND OF THE INVENTION

The present invention relates generally to software installation and licensing tools and more particularly to a removable media-based unified application installer and license management facility.

Software installation and licensing tools are well known in the art. Typically, software installation and licensing tools are comprised of processes whereby the customer uses an activation code supplied by the seller to enable use of the application once it has been installed on a device. The application is installed onto the device using synchronization software supplied by the device manufacturer. The activation code is based upon the device name, thereby binding the application to the device, and entered by the user when they first use the application.

The main problem with conventional software installation and licensing tools is that these tools were designed for individual use, where the user purchases a single copy of the application and supplies the device name to the seller as part of the purchase process, allowing the seller to create a unique activation code based upon the device name. Such a process generally breaks down when the customer desires to purchase large quantities of the software. In such a case, the customer must provide a list of unique device names or the seller creates a single activation code that works across all the devices. These processes present a challenge for the customer since they must install the application, launch the application and manually enter the activation code, whether unique or general, for every device. Also, if the seller provides a single activation code that works across all devices, the anti-piracy measures inherent in the use of an activation code based upon the device name may be easily circumvented.

Another problem with conventional software installation and licensing tools is that the installation process and use of an activation code based upon a device name assumes the customer will not migrate the application to another device and the new device will not have the same name as the original device. This is counter intuitive to traditional desktop application licensing methods where a serial number is used to prevent piracy. The customer however, has rights to use the software across multiple devices as long as the software is only installed on a single device. The desire of the seller to prevent piracy by binding the application to a specific device inhibits the user's ability to easily transfer the application and license to another device.

Yet another problem with conventional software installation and licensing tools is that the licensing method uses an activation code based upon the device name, which implies the customer must supply the device name at time of purchase. If the device name changes, then the activation code is invalidated, requiring the customer to contact the seller to request a new activation code based upon the new device name. While this process may seem plausible for individual sales, it quickly becomes untenable when large quantities of devices are involved or the device names change frequently.

There is therefore a need in the art for a removable media-based unified application installer and license management facility which overcomes the disadvantages of the prior art. The application installer and license management facility preferably provides a process whereby a seller may distribute an application, one or more licenses, and an installation application using removable media. The application installer and license management facility further preferably provides a means by which a user may employ the removable media to transport files from device to device, insert the removable media into the device causing the installation application to automatically launch, and use the installation application to alternately install the application and a single license onto the device, re-install the application and license onto a previously licensed device without using an additional license, and un-install the application and license from the device, thereby, recouping the license for use on another device.

### SUMMARY OF THE INVENTION

In accordance with one aspect of the invention, a removable media-based unified application installer and license management facility includes a desktop based package application for packaging an application and supporting files into an application package, a licensing application for allowing a seller to enter the number of licenses and provision a removable media with the application package and the licenses, and an installation application for use by the user to manage the installation process and licensing of the devices. The removable media facilitates the transport of the files from device to device and prevents piracy of the licenses by binding the licenses and the installation application to a unique removable media alphanumeric identifier.

The package application may allow the seller to create new file groups, edit existing file groups, and convert file groups into the application package. The licensing application may be used by the seller to provision the removable media with the application package and licenses. The licensing application may provide user interface elements for selecting the number of licenses to install, entering customer information for tracking purposes and may use the name of the application package to name the removable media when provisioned.

The licensing application may maintain a log file of all the removable media provisioned by the licensing application. A provisioning device may be used by the licensing application to install the application package and licenses onto the removable media. The provisioning device may have a removable media slot, such as a Secure Digital flash memory reader/writer. The licensing application and application package may reside on the provisioning device. The installation application may reside on the removable media and may be used to manage the installation of the application package and licenses onto devices. The installation application may manage the pool of licenses installed onto the removable media and as the application package and license is installed, re-installed, and un-installed across multiple devices, the installation application may adjust the license pool accordingly. The installation application may also provide a means to determine the status of the removable media with respect to total licenses, licenses remaining and devices licensed by the removable media. Removable media may be any type of read-write media, such as Secure Digital flash media, that is used by devices to store data.

In accordance with another aspect of the invention, an application installer and license management facility method includes the step of distributing an application, one or more licenses, and an installation application on a removable media.

In accordance with yet another aspect of the invention, an application installer and license management facility system includes a first processor operable to package an application and supporting files into an application package, execute a licensing application for allowing a seller to enter the number of licenses, and provision a removable media with the application package and the licenses, and a second processor operable to execute an installation application for use by a user to manage an installation process and license a device.

In accordance with another aspect of the invention, a computer readable medium includes a code segment operable to package an application and supporting files into an application package, a code segment operable to execute a licensing application for allowing a seller to enter the number of licenses, a code segment operable to provision a removable media with the application package and the licenses, and a code segment operable to execute an installation application for use by a user to manage an installation process and license a device.

In accordance with yet another aspect of the invention, an application installer and license management facility method includes the steps of packaging an application and supporting files into an application package, executing a licensing application for allowing a seller to enter the number of licenses, provisioning a removable media with the application package and the licenses, and executing an installation application for use by a user to manage an installation process and license a device.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one embodiment of the invention in detail, it is to be understood that the invention is not limited in its application to the details of design and to the sequence of steps and processes set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other methods and systems for carrying out the several purposes of the present invention. It is important, therefore, that the claims be regarded as including such equivalent methods and systems insofar as they do not depart from the spirit and scope of the present invention.

### BRIEF DESCRIPTION OF THE DRAWINGS

The present disclosure may be better understood and its numerous features and advantages made apparent to those skilled in the art by referencing the accompanying drawings.

FIG. 1 is a schematic representation of a representative hardware environment in which the present invention may be practiced;

FIG. 2 is a flow diagram illustrating a packaging application in accordance with the present invention;

FIG. 3 is a flow diagram illustrating a licensing application in accordance with the present invention; and

FIG. 4 is a flow diagram illustrating an installation application in accordance with the present invention.

### DETAILED DESCRIPTION OF THE INVENTION

The present invention relates to a removable media-based unified application installer and license management facility including a desktop based package application for packaging an application and supporting files into an application package, a licensing application for allowing a seller to enter the number of licenses and provision a removable media with the application package and the licenses, and an installation application for use by the user to manage the installation process and licensing of the devices. The removable media facilitates the transport of the files from device to device and prevents piracy of the licenses by binding the licenses and the installation application to a unique removable media alphanumeric identifier.

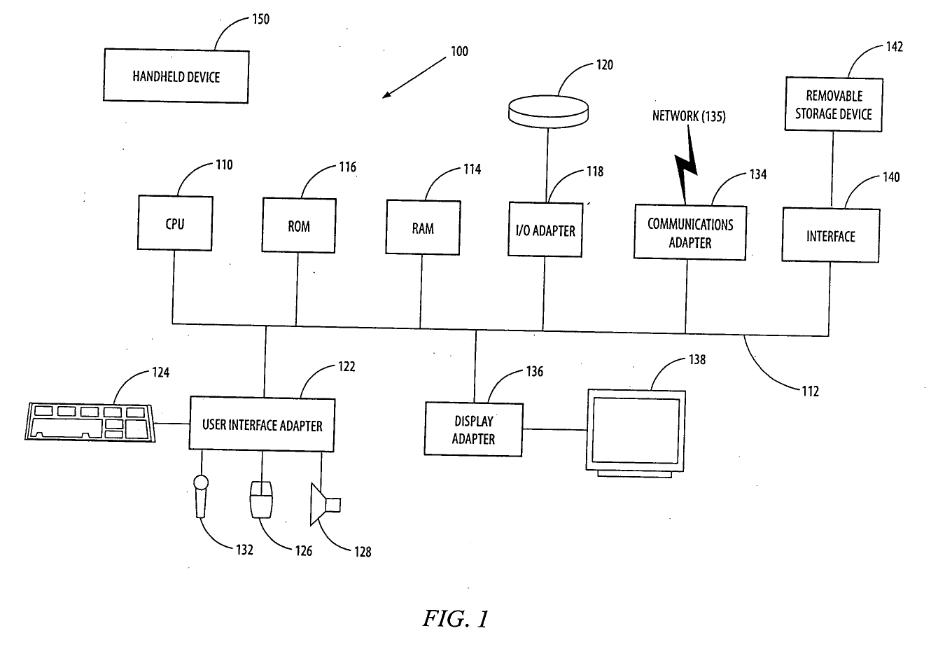

The present invention may be implemented using hardware, software, or a combination thereof and may be implemented in a computer system generally designated 100 or other processing system as shown in FIG. 1. In one aspect of the invention, the invention is directed toward the computer system 100 capable of carrying out the functionality described herein. The computer system 100 may include one or more processors 110. The processor 110 may be connected to a communication bus 112. Various software embodiments are described in terms of this exemplary computer system 100. After reading this description, it will become apparent to one skilled in the art how to implement the invention using other computer systems and/or computer architectures.

Computer system 100 may also include a main memory, preferably random access memory (RAM) 114, a read only memory (ROM) 116, and a secondary memory including a secondary memory drive 118 and a secondary memory device such as a magnetic or optical disk 120. Computer system 100 may also include an interface 140 such as a USB interface, a PCI Express interface, and an ExpressCard interface. The interface 140 may provide an interface to a removable storage device or media 142 such as a flash memory card. As will be appreciated, the removable storage device 142 may include a computer usable storage medium having stored therein computer software and/or data. Interface 140 may further allow software and data to be transferred from the removable storage device 142 to the computer system 100 and to a handheld device 150.

Computer system 100 may also include a communications adapter 134 for communication with a network 135 and remote devices such as the handheld device 150. Communications adapter 134 allows software and data to be transferred between the computer system 100 and external devices including storage devices and the handheld device 150. Examples of communications adapter 134 may include a modem, a network interface (such as an Ethernet card), a communications port, and a PCMCIA slot and card. Software and data transferred via communications adapter 134 are in the form of signals which can be electronic, electromagnetic, optical or other signals capable of being received by communications adapter 134. These signals are provided to the communications adapter 134 via a channel. The channel may carry signals and may be implemented using wire, cable, fiber optic cable, phone lines, cellular phone link, an RF link and other communications channels.

In this description, the terms “computer program medium” and “computer usable medium” are used to generally refer to media such as removable storage devices 142, the secondary memory device 120 including a hard disk installed in the secondary memory drive 118, and signals. These computer program products are means for providing software to the computer system 100 and the handheld device 150.

Computer programs and software applications (also called computer control logic) may be stored in main memory 114, secondary memory 120, and in the removable storage device 142. Computer programs may also be received via communications adapter 134. Such computer programs, when executed, enable the computer system 100 and the handheld device 150 to perform the features of the present invention as discussed herein. In particular, the computer programs, when executed enable the processor 110 and a handheld device processor (not shown) to perform the features of the present invention. Accordingly, such computer programs represent controllers of the computer system 100 and the handheld device 150.

In an embodiment where the invention is implemented using software, the software may be stored in a computer program product and loaded into the computer system 100 and handheld device 150 using the removable storage device 142 and/or communications adapter 134. The control logic (software), when executed by the processor 110 and handheld device processor, causes the processor 110 and handheld device processor to perform the functions of the invention as described herein. In one aspect of the invention, the administrative application may be stored in the RAM 114 or in the secondary memory 120 and the assignment application may be stored in the removable storage device 142.

In another aspect of the invention, the invention may be implemented primarily in hardware using, for example, hardware components such as application specific integrated circuits (ASICS). Implementation of the hardware state machine so as to perform the functions described herein will be apparent to persons skilled in the relevant art. In yet another embodiment, the invention may be implemented using a combination of both hardware and software.

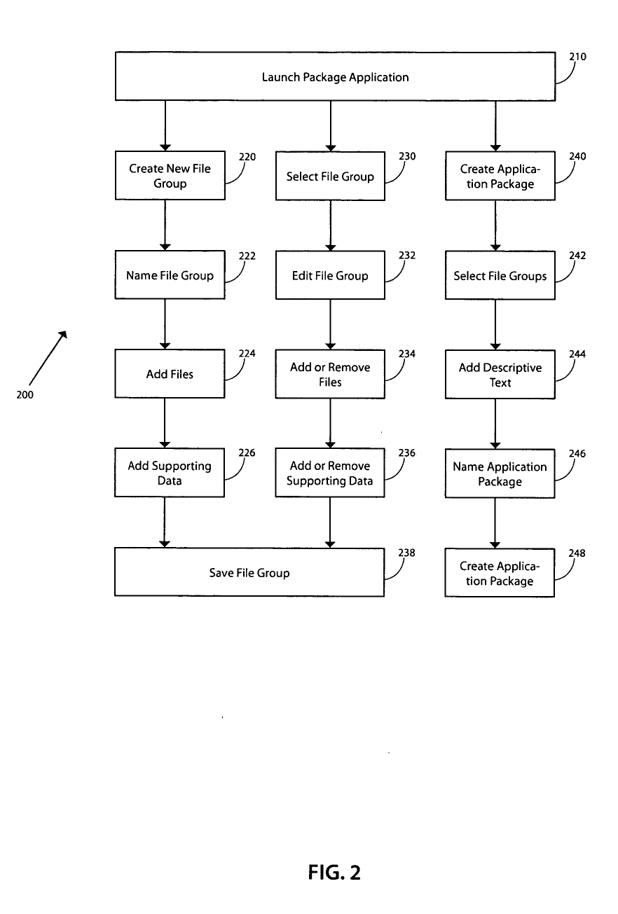

In one aspect of the invention, the package application generally designated 200 may be used to create an application package including one or more file groups for use by the licensing application as illustrated in FIG. 2. After the package application is launched in a step 210, a new file group may be created in a step 220. In a step 222 the new file group may be named and in a step 224 files may be added to the new file group. Supporting data such as commentary information, To Do List, Memo Pad and Date Book events may be added in a step 226. The new file group may be saved to the RAM 114 or the secondary memory device 120 in a step 238.

To edit an existing file group, the existing file group may be selected in a step 230 and selected for editing in a step 232. Files may be added or removed from the existing file group in a step 234. Supporting data may be added or removed from the file group in a step 236 and the edited file group may be saved to the RAM 114 or the secondary memory device 120 in a step 238.

The application package may be created in a step 240 by selecting file groups in a step 242. Descriptive text may be added to the application package to help describe the files contained in the application package in a step 244. A name for the application package may be provided in a step 246 and the application package saved to the RAM 114 or the secondary memory device 120 in a step 248.

The process of creating and managing file groups, as well as creating the application package, may be part of an overall application provisioning system where the removable media 142 is provisioned with an application as orders are received or processed for shipment.

The licensing application may be used by a seller to provision the removable media 142 with the application package and licenses. The licensing application provides user interface elements for selecting the number of licenses to install and entering customer information for tracking purposes, and uses the name of the application package to name the removable media 142 provisioned. The licensing application may maintain a log file of all the removable media 142 provisioned by the licensing application. The licensing application may be employed by the user to provision the removable media 142 with the application package and licenses. To accomplish this, the licensing application may be installed on a provisioning device such as computer system 100. Alternatively, the provisioning device may include a low cost handheld device having an interface for reading and writing to the removable media 142.

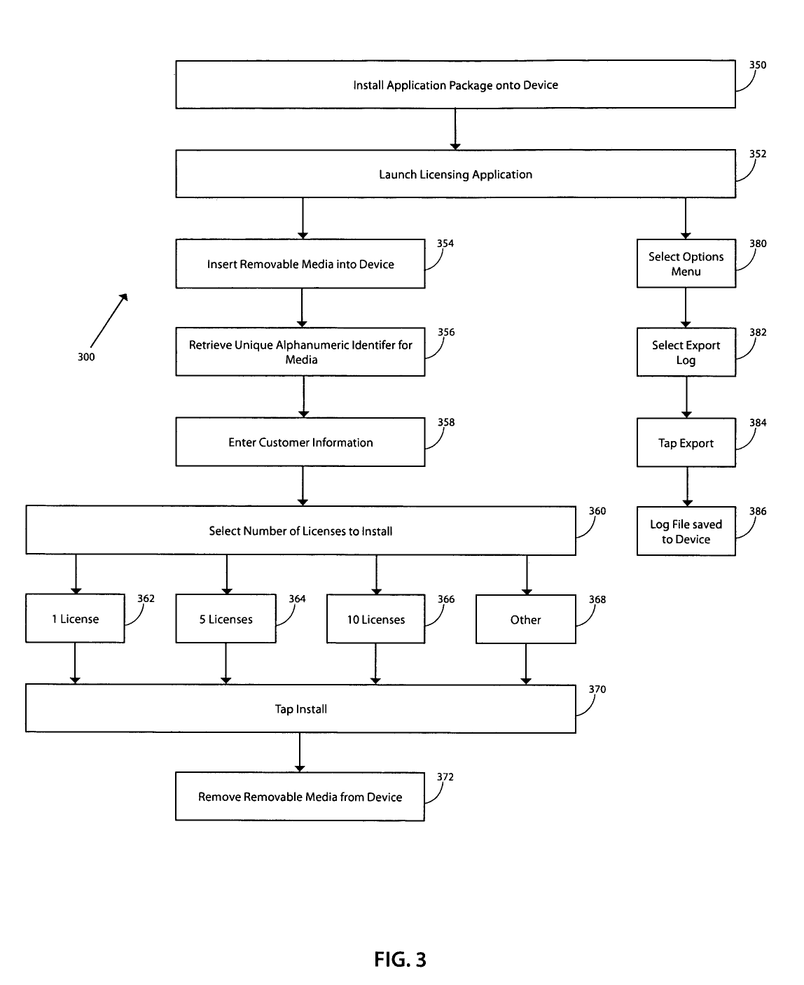

With reference to FIG. 3, a method generally designated 300 may include a step 350 in which the application package may be installed onto the provisioning device 100. To provision the removable media 142 with the application package and licenses, the licensing application may be launched in a step 352 and the removable media 142 coupled to the interface 140 in a step 354. In a step 356 the licensing application may retrieve an alphanumeric identifier for the removable media 142. Customer identification may be entered by the user in a step 358. The number of licenses to be installed may be selected in a step 360. One license may be selected in a step 362, five licenses may be selected in a step 364, ten licenses may be selected in a step 366, and another number of licenses may be selected in a step 368. In a step 370 the number of licenses selected and the application package may be installed on the removable media 142. Once provisioning is complete, a log entry may be recorded and can be saved to RAM 114 by selecting an Options Menu (not shown) in a step 380, selecting an Export Log button (not shown) in a step 382, exporting the log in a step 384 and saving the log in a step 386. The removable media 142 may be de-coupled from the provisioning device 100 in a step 372. The removable media 142 may then be sent to a customer. The licensing application may be part of a larger manufacturing or sales order management process, whereby the provisioning of the removable media 142 may be based upon a process whereby the customer supplies the unique alphanumeric identifier to the seller either manually or using an automated method where the unique alphanumeric identifier is read as the transaction is being processed.

The installation application may reside on the removable media 142 and be used to manage the installation of the application package and licenses onto handheld devices 150. The installation application may manage a pool of licenses installed onto the removable media 142 and as the application package is installed, re-installed, and un-installed across multiple handheld devices 150, the installation application may adjust the license pool accordingly. The installation application may also provide a means to determine the status of the removable media 142 with respect to the total licenses, licenses remaining and handheld devices 150 licensed by the removable media 142.

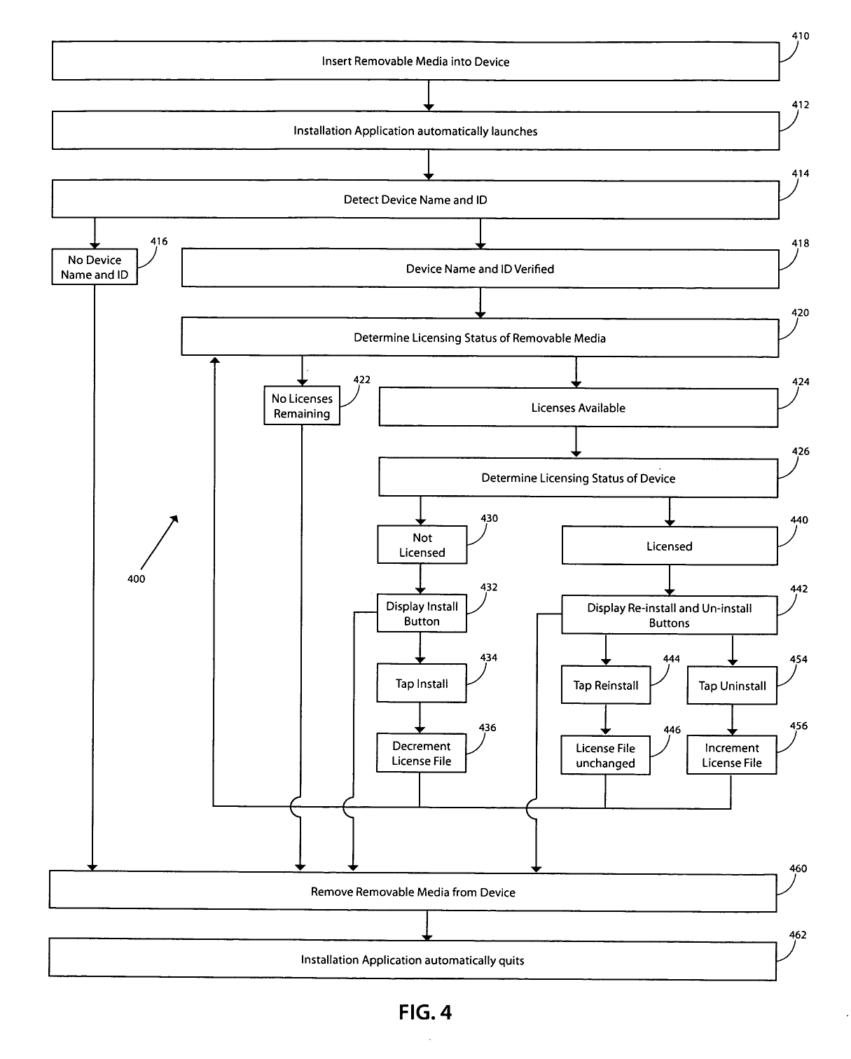

As shown in FIG. 4, a method generally designated 400 includes a step 410 in which the removable media 142 may be inserted into a handheld device 150. Upon insertion, the installation application may be launched in a step 412. In a step 414 the installation application may detect the hand held device 150 name and identification. If the hand held device 150 does not have a device name and identification as determined in a step 416, the user may remove the removable media 142 from the hand held device 150 in a step 460 and the installation application may quit in a step 462.

If the hand held device 150 does have a name and identification as verified in a step 418, the installation application may determine the licensing status of the removable media 142 in a step 420 to ensure that there is at least one license remaining to be installed. If there are no licenses remaining on the removable media 142 as determined in a step 422, the user may remove the removable media in step 460 and the installation application may quit in step 462. If there is at least one license remaining on the removable media 142 as determined in a step 424, then the installation application may determine the licensing status of the hand held device 150 in a step 426.

If the hand held device 150 is not licensed as determined in a step 430, an Install button (not shown) may be displayed in a step 432. In a step 434 the license may be installed on the hand held device 150 and in a step 436 the number of licenses available on the removable media 142 may be decremented by one. Method 400 may then return to step 420 to determine the licensing status of the removable media 142.

If the hand held device 150 is licensed as determined in a step 440, Re-install and Un-install buttons (not shown) may be displayed in a step 442. The user may either choose to remove the removable media 142 in step 460, re-install the license or un-install the license. The license may re-installed in a step 444 and the license file left unchanged in a step 446. Method 400 may then return to step 420 to determine the licensing status of the removable media 142.

The license may be un-installed in a step 454 and the license file incremented in a step 456. Method 400 may then return to step 420 to determine the licensing status of the removable media 142.

The present invention overcomes the disadvantages of the prior art by providing a process a process whereby a seller may distribute an application, one or more licenses, and an installation application using removable media. The application installer and license management facility provide a means by which a user may employ the removable media to transport the files from device to device, insert the removable media into the device causing the installation application to automatically launch, and use the installation application to alternately install the application and a single license onto the device, re-install the application and license onto a previously licensed device without using an additional license, and un-install the application and license from the device, thereby, recouping the license for use on another device

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. An application installer and license management facility method comprising the step of:
distributing an application, one or more licenses, and an installation application on a removable media.

2. The application installer and license management facility method of claim 1, wherein the removable media is read by a hand held device causing the installation application to automatically launch on the handheld device.

3. The application installer and license management facility method of claim 2, wherein the installation application is used to alternately install the application and a license onto the hand held device.

4. The application installer and license management facility method of claim 2, wherein the installation application is used to re-install the application and a license onto a previously licensed hand held device without using an additional license.

5. The application installer and license management facility method of claim 2, wherein the installation application is used to un-install the application and a license from the hand held device, thereby recouping the license for use on another hand held device.

6. An application installer and license management facility system comprising:
a first processor operable to package an application and supporting files into an application package, execute a licensing application for allowing a seller to enter the number of licenses, and provision a removable media with the application package and the licenses; and
a second processor operable to execute an installation application for use by a user to manage an installation process and license a device.

7. The application installer and license management facility system of claim 6, wherein the device includes a hand held device.

8. The application installer and license management facility system of claim 6, wherein the licenses are bound to the removable media using a removable media unique alphanumeric identifier.

9. The application installer and license management facility system of claim 6, wherein the application package enables the creation of new file groups, the editing of existing file groups, and the conversion of file groups into the application package.

10. The application installer and license management facility system of claim 6, wherein the first processor is operable to execute the licensing application to enable a seller to provision the removable media with the application package and the licenses.

11. The application installer and license management facility system of claim 6, wherein the second processor is operable to execute the licensing application to provide user interface elements for selecting a number of licenses for installation on a number of devices.

12. The application installer and license management facility system of claim 6, wherein the second processor is operable to execute the licensing application to provide user interface elements for entering a customer information for tracking purposes.

13. The application installer and license management facility system of claim 6, wherein the second processor is operable to execute the licensing application to provide user interface elements for using an application package name to name the removable media.

14. A computer readable medium comprising:
a code segment operable to package an application and supporting files into an application package;
a code segment operable to execute a licensing application for allowing a seller to enter the number of licenses;
a code segment operable to provision a removable media with the application package and the licenses; and
a code segment operable to execute an installation application for use by a user to manage an installation process and license a device.

15. The computer readable medium of claim 14, wherein the device includes a hand held device.

16. The computer readable medium of claim 14, wherein the licenses are bound to the removable media using a removable media unique alphanumeric identifier.

17. The computer readable medium of claim 14, wherein the application package enables the creation of new file groups, the editing of existing file groups, and the conversion of file groups into the application package.

18. The computer readable medium of claim 14, wherein the licensing application enables a seller to provision the removable media with the application package and the licenses.

19. The computer readable medium of claim 14, wherein the licensing application provides user interface elements for selecting a number of licenses for installation on a number of devices.

20. An application installer and license management facility method comprising the steps of:
packaging an application and supporting files into an application package;
executing a licensing application for allowing a seller to enter the number of licenses;
provisioning a removable media with the application package and the licenses; and
executing an installation application for use by a user to manage an installation process and license a device.
